(19) United States
(12) Patent Application Publication
(10) Pub. No.: US 2013/0194310 A1
(43) Pub. Date: Aug. 1, 2013

(54) AUTOMATICALLY ADAPTATION OF APPLICATION DATA RESPONSIVE TO AN OPERATING CONDITION OF A PORTABLE COMPUTING DEVICE

(71) Applicants: Venugopal Vasudevan, Palatine, IL (US); Silviu Chiricescu, Chicago, IL (US); Gilles Drieu, San Francisco, CA (US); Sriram Yadavalli, Redwood City, CA (US)

(72) Inventors: Venugopal Vasudevan, Palatine, IL (US); Silviu Chiricescu, Chicago, IL (US); Gilles Drieu, San Francisco, CA (US); Sriram Yadavalli, Redwood City, CA (US)

(73) Assignee: GENERAL INSTRUMENT CORPORATION, Horsham, PA (US)

(21) Appl. No.: 13/358,670

(22) Filed: Jan. 26, 2012

(51) Int. Cl. G09G 5/00

(52) U.S. Cl. 345/660; 345/619

(57) ABSTRACT

A method and apparatus for displaying data associated with a first application and data associated with a second application on a portable computing are disclosed. Data from physical and virtual sensors is captured and used to determine a context vector. The context vector may provide information about portable computing device usage. Application modes associated with the context vector by the first application and by the second application are identified in addition to a container mode associated with the context vector by a display container. In one embodiment, the display container is a virtual display space used to identify and describe data for display on a display device. A display configuration is determined form the application modes associated with the context vector and the container mode associated with the context vector and used to display data on a display device.

### FIELD OF THE DISCLOSURE

The present disclosure relates generally to data display and more particularly to modifying display of data responsive to a context associated with device usage.

### BACKGROUND

Managing applications and data associated with applications is well understood for desktop or laptop computing environments, which allow users to easily navigate between data displayed by multiple applications. However, portable computing devices, such as smartphones or tablet computers, have more limited application management capabilities. Current methods multi-tasking using a portable computing device require that an application with which a user is currently interacting occupies the foreground of the display, while other executing applications are obscured from view or present a limited view of applications that are executing. This limits the data visible to a user to data associated with the single application with which the user is currently interacting. Additionally, this also requires a portable computing device user to provide additional inputs for navigating between applications to select an application for interaction.

### BRIEF DESCRIPTION OF THE DRAWINGS

The accompanying Figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

Figure (FIG.) 1 is a block diagram of a computing architecture in accordance with some embodiments.

FIG. 2 is a block diagram of a portable computing device in accordance with some embodiments.

FIG. 3 is an event diagram of flow chart of a method for modifying a display configuration of a portable computing device in accordance with some embodiments.

FIG. 4 is a flow chart of a method for determining a display configuration of a portable computing device using a mode associated with a context vector by a first application in accordance with some embodiments.

FIG. 5 is a flow chart of a method for determining a display configuration of a portable computing device using a mode associated with a context vector by a display container in accordance with some embodiments.

FIG. 6 is a flow chart of a method for determining display of a first application and a second application using display attributes associated with a context vector by a first application, a second application and a display container in accordance with some embodiments.

FIGS. 7A-7C are examples of modifying display of data associated with applications based on display attributes associated with a context vector in accordance with some embodiments.

Skilled artisans will appreciate that elements in the Figures are illustrated for simplicity and clarity and have not necessarily been drawn to scale. For example, the dimensions of some of the elements in the Figures may be exaggerated relative to other elements to help to improve understanding of embodiments of the present invention.

The apparatus and method components have been represented where appropriate by conventional symbols in the drawings, showing the specific details that are pertinent to understanding the embodiments of the present invention so as not to obscure the disclosure with details that will be readily apparent to those of ordinary skill in the art having the benefit of the description herein.

### DETAILED DESCRIPTION

The following describes a method and apparatus for displaying data associated with a first application and a second application. A context vector is determined from data describing a position associated with a device and an operating condition associated with the device. A first application mode associated with a first application and with the context vector is identified and a second application mode associated with a second application and with the context vector is identified. Additionally, a container mode associated with the context vector and with a display container in which the first application and the second application are displayed is identified. For example, the display container comprises a virtual display space where data is displayed on a display device based on location, size and other information in the virtual display space. A display configuration is determined based on the first application mode, the second application mode and the container mode. The display configuration identifies display attributes of the first application, display attributes of the second application and display attributes of the container mode. The first application and the second application are displayed on a display device using the display configuration.

In the following description, for purposes of explanation, numerous specific details are set forth to provide a thorough understanding of the invention. However, it will be apparent to one skilled in the art that the invention can be practiced without these specific details. In other instances, structures and devices are shown in block diagram form in order to avoid obscuring the invention. System Overview

FIG. 1 is a block diagram of one embodiment of a computing architecture 100. In the embodiment shown by FIG. 1, the computing architecture 100 includes a portable computing device 110, one or more servers 120A, 120N (also referred to individually and collectively using reference number 120), a content provider 130 and a network 140. However, in different embodiments, the computing architecture 100 may include different and/or additional components than those depicted by FIG. 1.

The portable computing device 110 is any device with data processing and data communication capabilities. Examples of a portable computing device 110 include a smartphone, a tablet computer, a netbook computer, a laptop computer or any other suitable device. The portable computing device 110 receives data from one or more servers 120A, 120N and/or from a content provider 130 via the network 140. In one embodiment, the portable computing device 110 executes one or more applications exchanging data with one or more servers 120A, 120N or a content provider 130. For example, the portable computing device 110 executes an electronic mail (e-mail) client application exchanging data associated with one or more e-mail accounts with one or more servers 120A, 120N. As another example, the portable computing device 110 executes a social networking application receiving social network data associated with an account from a server 120 and/or transmitting social network data associated with the account to the server 120.

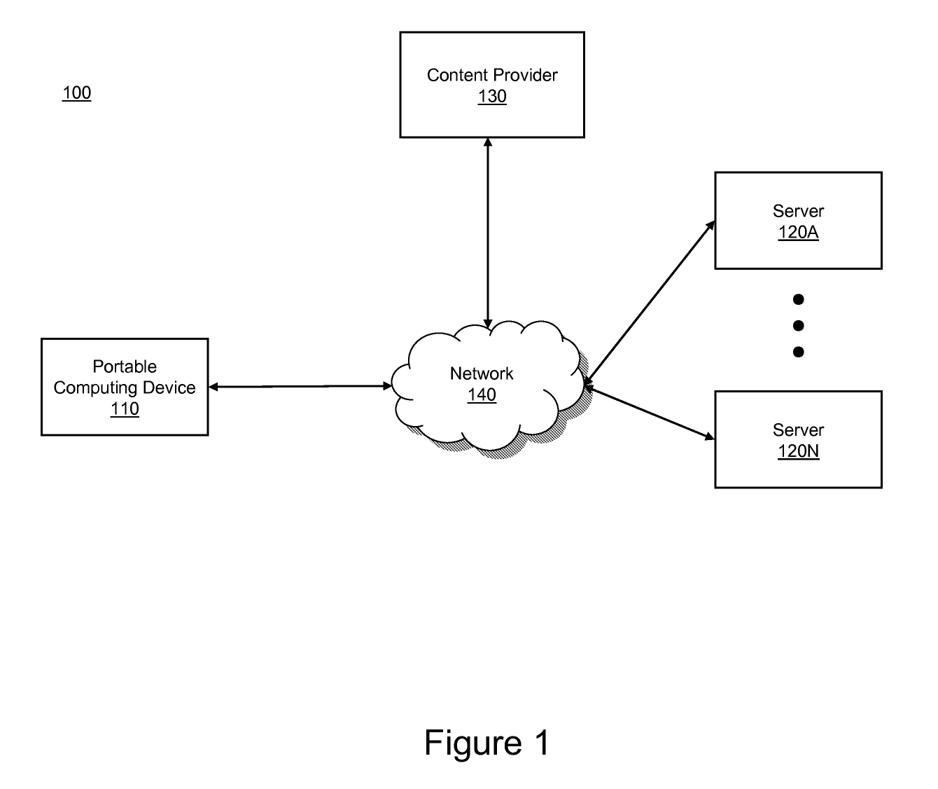

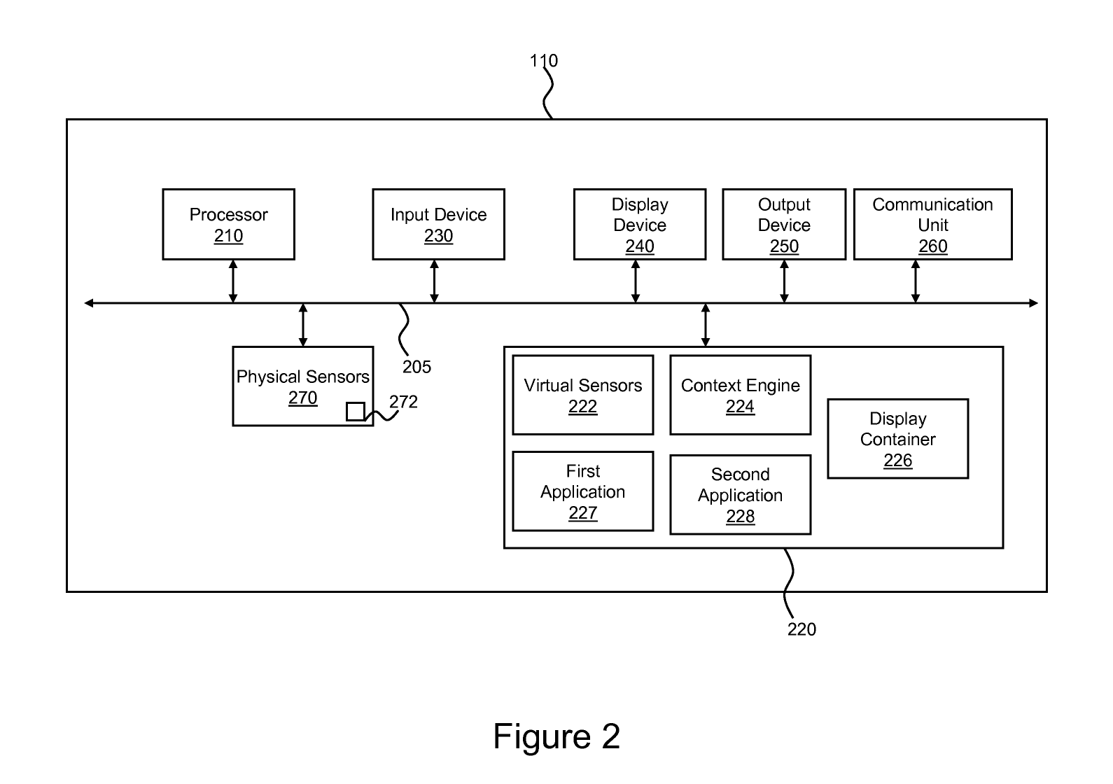

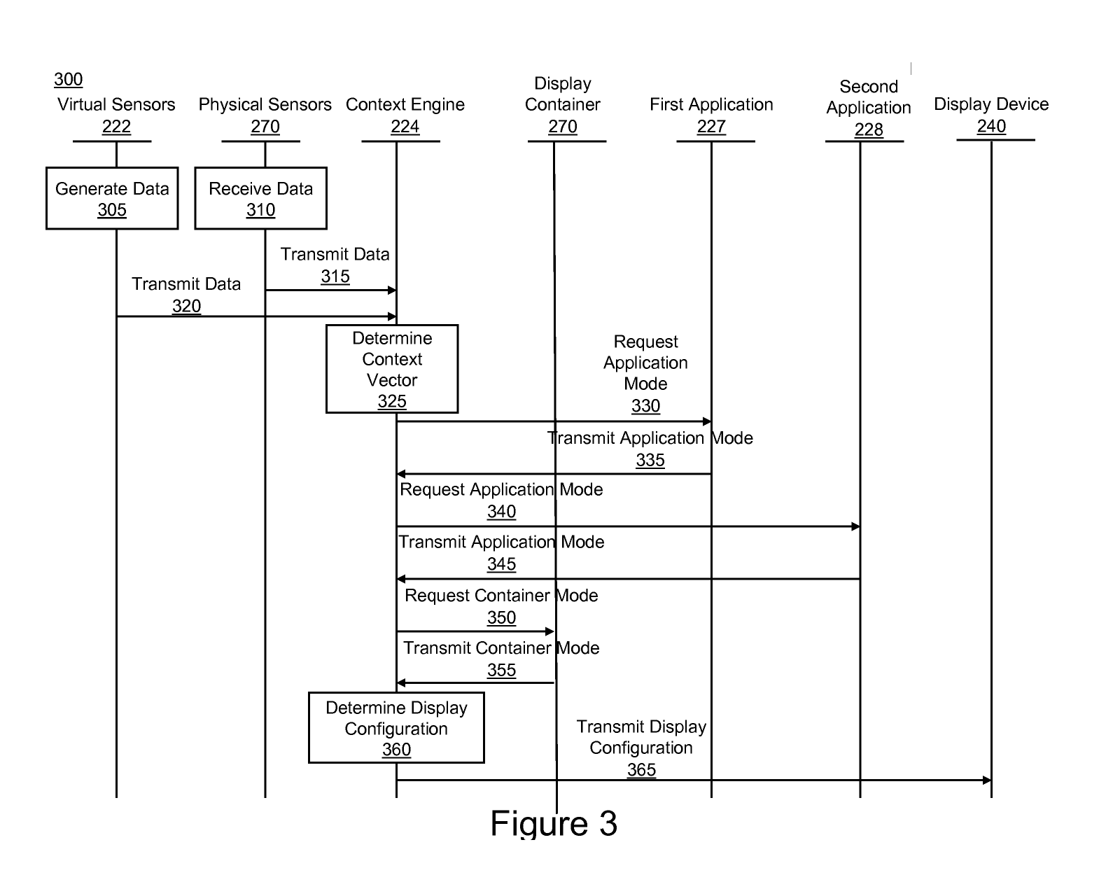

In one embodiment, the portable computing device 110 also receives executable data or instructions from a server 120 via one or more networks 140 that, when executed by the portable computing device 110, executes an application enabling user interaction with content. Additionally, the portable computing device 110 may receive video content, image content or other content from a content provider 130 and present the received content to a user. For example, the portable computing device 110 displays video content, or image content, from a content provider 130 on a display device. The portable computing device 110 is further described below in conjunction with FIG. 2. In certain embodiments, the methods described below in conjunction with FIGS. 3-6 are also applicable to a large-screen devices, such as a television, that are not portable, but include a subset of the components further described below in conjunction with FIG. 2.

Servers 120A, 120N are computing devices having data processing and data communication capabilities that exchange data with the portable computing device 110 via a network 140. For example, a server 120 provides data such as a web page, audio content, video content, e-mail, calendar information, social networking data or other content via a network 140 to the portable computing device 110 and/or receives data from a portable computing device 110 via the network 140. In one embodiment, a server 120 receives a data request from the portable computing device 110 via a network 140 at a specified time interval and transmits data to the portable computing device 110 responsive to receiving the data request or stores data from the portable computing device 110 included in the received data request. In another embodiment, a server 120 pushes data to the portable computing device 110 using a network 140 at a specified interval or responsive to a modification to the data.

The content provider 130 comprises one or more computing devices transmitting video content, image content, audio content or other content to the portable computing device 110 via the network 140. For example, the content provider 130 is a video hosting web site, a television provider or another source of video, image or audio content. As another example, the content provider 130 is a streaming video source transmitting streaming video content. In one embodiment, the content provider 130 exchanges data with the portable computing device 110 via a network 140 at predetermined intervals either by pushing content to the portable computing device 110 at periodic intervals or by transmitting data to the portable computing device 110 responsive to receiving a data request from the portable computing device 110.

The network 140 is a conventional type for data, video and/or audio transmission. In various embodiments, a network 140 is a wired network, a wireless network or a combination of wireless and wired networks. In one embodiment, the network 140 is associated with a provider, which is an entity supplying and/or maintaining at least a subset of the components comprising the network 140.

The network 140 may comprise a local area network (LAN), a wide area network (WAN) (e.g., the Internet), and/or any other interconnected data path across which multiple devices may communicate. The network 140 may also be coupled to, or include, portions of a telecommunications network for sending data in a variety of different communication protocols. The network 140 may be implemented in a variety of techniques, such as satellite link, wireless broadcast links and/or any other suitable configuration and may have any number of configurations, such as a star configuration, a token ring configuration or another configuration known in the art. In yet another embodiment, the network 140 may be a peer-to-peer network. In some embodiments, the network 140 includes Bluetooth communication networks or a cellular communications network for sending and receiving data such as via short messaging service (SMS), multimedia messaging service (MMS), hypertext transfer protocol (HTTP), direct data connection, wireless application protocol (WAP), email or other types of data known in the art.

In one embodiment, the network type identifies a protocol used to communicate voice and/or data, such as Transmission Control Protocol/Internet Protocol (TCP/IP), Global System for Mobile (GSM), Code Division Multiple Access (CDMA) system, Universal Mobile Telecommunications System (UMTS), General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax) or any other suitable protocol. A storage device included in a component within a network 140 includes data identifying the network type.

FIG. 2 is a block diagram of one embodiment of a portable computing device 110. In the embodiment shown by FIG. 2, the portable computing device 110 includes a processor 210, a storage device 220, an input device 230, a display device 240, an output device 250, a communication unit 260 and/or one or more physical sensors 270 that are coupled together via a bus 205. However, in different embodiments, the portable computing device 110 may include different and/or additional components than those illustrated by FIG. 2.

The processor 210 processes data or instructions and may comprise various computing architectures. For example, the processor 210 processes data or instructions using a complex instruction set computer (CISC) architecture, a reduced instruction set computer (RISC) architecture, an architecture implementing a combination of instruction sets or any other suitable instruction set. Although FIG. 2 shows a single processor 210, in other embodiments, the portable computing device 110 may include multiple processors. The processor 210 transmits, processes and/or retrieves data from the storage device 220, the input device 230, the display device 240, the output device 250, the communication unit 260 and/or one or more physical sensors 270.

The storage device 220 stores data and/or instructions that, when executed by the processor 210, cause the processor 210 to perform one or more actions or to provide one or more types of functionality. The data and/or instructions included in the storage device 220 may comprise computer-readable code that, when executed by the processor 210, performs one or more of the methods described herein and/or provides at least a subset of the functionality described herein. The storage device 220 may comprise a dynamic random access memory (DRAM), a static random access memory (SRAM), a hard disk, an optical storage device, a magnetic storage device, a Read Only Memory (ROM), a Programmable Read Only Memory (PROM), an Erasable Programmable Read Only Memory (EPROM), an Electrically Erasable Programmable Read Only Memory (EEPROM), a Flash memory or another memory device known in the art. The storage device 220 may be a persistent storage device, a non-persistent storage device or a combination of a persistent storage device and a non-persistent storage device, in various embodiments. The storage device 220 is coupled to the processor 210, the input device 230, the display device 240, the output device 250, the communication unit 260 and/or one or more physical sensors 270 via the bus 205.

In the embodiment shown by FIG. 2, the storage device 220 includes one or more virtual sensors 222, a context engine 224, a display container 226, a first application 227 and a second application 228. In other embodiments, the storage device 220 may include different and/or additional components than those shown in FIG. 2. A virtual sensor 222 comprises instructions that, when executed by the processor 210, generates data describing an operating condition associated with the portable computing device 110. In one embodiment, a virtual sensor 222 receives data from one or more of the input device 230, the communication unit 260 and/or a physical sensor 270 and determines an operating condition associated with the portable computing device 110 by applying one or more processes or rules to the received data. In one embodiment, a virtual sensor 222 determines whether a second device is coupled to the portable computing device 110. For example, a virtual sensor 222 determines whether a second portable computing device is communicating with the portable computing device 110 via the communication unit 260 or whether the portable computing device 110 is coupled to an external display device via the communication unit 260.

A virtual sensor 222 may be configured to identify one or more trigger conditions and to generate data responsive to identifying a trigger condition. In various embodiments, a trigger condition is a change in location of the portable computing device 110, a change in orientation of the portable computing device 110, receipt of data by the portable computing device 110, execution of an application by the portable computing device 110, receipt of data from an external device by the portable computing device 110 or any other suitable modification of a portable computing device operating condition and/or orientation. For example, a trigger condition may be receipt of a telephone call or a text message. Additional examples include the portable computing device 110 entering a specified location or receiving a type of data from a user or from an external device. In one embodiment, one or more trigger conditions may be user-defined.

In one embodiment, a virtual sensor 222 indicates the amount or frequency of interaction with the portable computing device 110 based on data from one or more input devices 230. For example, the virtual sensor 222 applies a process to data from an orientation sensor 272 and a touch-screen or keyboard to describe the amount or frequency of interaction with the portable computing device 110. Another virtual sensor 222 may determine a number of applications executed by the portable computing device 110 based on data from the processor 210. Another example virtual sensor 222 determines a semantic location associated with the portable computing device 110 using data from an input device 230 and from the storage device 220. For example, the virtual sensor 222 determines a label or name associated with location data received from an input device 230. Examples of labels associated with location data include a user-defined name or a street address associated with a latitude and longitude. Similarly, a virtual sensor 222 may determine a semantic position associated with an orientation of and/or interaction with the portable computing device 110 based on data from one or more physical sensors 270. The semantic position associates a label or name with an orientation of the portable computing device 110 and/or an interaction with the portable computing device 110. For example, a semantic position may associate a label with data indicating pressure is applied to the portable computing device 110 while the portable computing device is in a first orientation. In various embodiments, different and/or additional virtual sensors 222 may be included.

The context engine 224 comprises instructions that, when executed by the processor 210, receives data from one or more physical sensors 270 and/or virtual sensors 222 and determines a context vector from the received data. The context vector describes an operating mode associated with the portable computing device 110. For example, the context vector is based on a position of the portable computing device 110, which is derived from data captured by the virtual sensors 222 and/or data captured from the physical sensors 270, an amount of user interaction with one or more applications executed by the portable computing device 110. In one embodiment, data from an environment including the portable computing device 110 is also used to determine the context vector. For example, data describing an amount of ambient lighting and/or ambient sound is received from one or more physical sensors 270 and used by the context engine 224 to determine the context vector.

The context vector may be used to approximate the amount of attention a user pays to the portable computing device 110. For example, a context vector associated with a first orientation of the portable computing device 110 and a first amount of user interaction with the portable computing device 110 may indicate that a user is actively using the portable computing device 110. A second context vector associated with a second orientation of the portable computing device 110 may indicate that a user is not using the portable computing device 110. Thus, determining a context vector may allow the display of different data by the portable computing device 110 based on an inferred amount of interaction a user has with the portable computing device 110.

In one embodiment, the context engine 224 stores a set of context vectors and selects a context vector from the set based on data from one or more physical sensors 270 and/or virtual sensors 222. For example, the context engine 224 includes context vectors associated with different values from one or more physical sensors 270 and/or virtual sensor 222 and selects the stored context vector having a highest similarity to data from one or more physical sensors 270 and/or virtual sensors 222. For example, the context engine 224 calculates the Hamming distance between data associated with stored context vectors and data received from one or more physical sensors 270 and/or virtual sensors 222 and selects a stored context vector using the Hamming distance.

The context engine 224 also determines a display configuration using the determined context vector. After determining the context vector, the context engine 224 determines an application mode associated with the context vector by one or more applications stored by the storage device 220. For example, the context engine 224 transmits a request to an application including the context vector and receives from the application an application mode corresponding to the context vector. In one embodiment, the context engine 224 determines the application mode of applications currently executed by the processor 210. The context engine 224 also retrieves a container mode associated with the context vector from a display container 226, which is further described below. Using one or more application modes and the container mode associated with the context vector, the context engine 224 determines a display configuration describing how data associated with one or more applications, and other data, is displayed. This allows the context engine 224 to modify presentation of different data based on interactions with the portable computing device 110 inferred from the context vector. Determination of a display configuration is further described below in conjunction with FIGS. 3-6.

The display container 226 comprises one or more display attributes associated with a context vector and used by the processor 210 to display data on the display device 240. In one embodiment, the display container 226 describes a virtual display space in which positioning and formatting information for data associated with one or more applications is stored and associated with locations on the display device 240. For example, data included in the virtual display space is mapped to locations on the display device 240. In one embodiment, data associated with one or more application is displayed within the virtual display space described by the display container 226, allowing the display container 226 to describe positioning and formatting of data associated with one or more applications.

In one embodiment, the display container 226 includes default display attributes used to present data from one or more applications or to present data not associated with an application; however, application-specific display attributes may supersede display attributes in the display container 226 to customize display of application-specific data. Alternatively, display attributes associated with the display container 226 are used when an application does not include display attributes. Hence, in some embodiments, display attributes associated with the display container 226 provide a more consistent appearance of data by different applications.

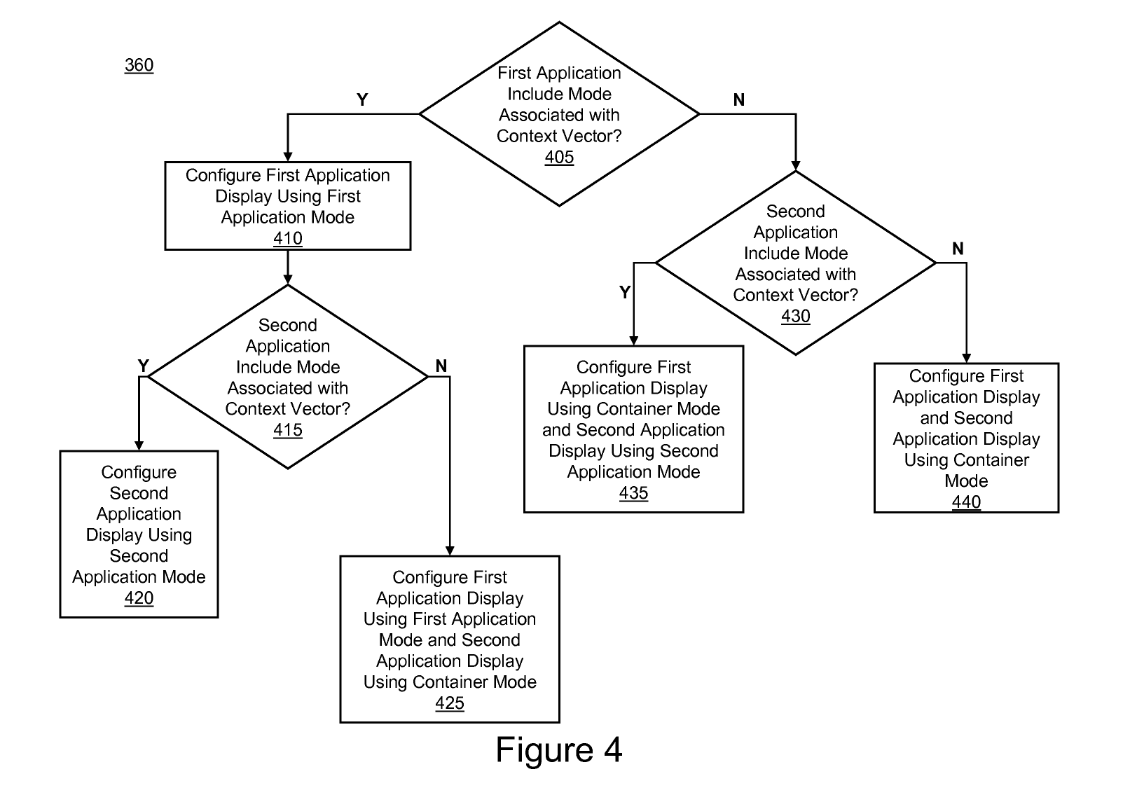

In one embodiment, the display container 226 includes a set of container modes associating one or more display attributes associated with different context vectors. The context engine 224 retrieves a container mode associated with a context vector to determine display attributes associated with the context vector by the display container 226. In various embodiments, display attributes from the container mode are used along with display attributes from application modes to modify the appearance of data on the display device 240 responsive to a context vector. Use of the display container 226 is further described below in conjunction with FIGS. 4-6.

In various embodiments, the functionality of the display container 226 and the context engine 224 may be interchanged or divided between the display container 226 and the context engine 224. For example, the display container 226 may perform the functionality described above as performed by the context engine 224. Alternatively, the context engine 224 may perform the functionality described above in conjunction with the display container 226. In other embodiments, the functionality described above may be divided between the display container 226 and the context engine 224 in any suitable manner.

The first application 227 and the second application 228 comprise instructions that, when executed by the processor 210, providing functionality to a user of the portable computing device 110 or to the portable computing device 110. For example, the first application 227 includes data for executing a web browser, allowing the portable computing device 110 to receive input identifying a content provider 130 or a server 120 via the input device 230 and to retrieve data from the identified content provider 130 or server 120 via the network 140. The second application 228 may include data for providing video content received from a content provider 130 via the display device 240. However, the first application 227 and the second application 228 may variously comprise instructions that, when executed by the processor 210, implement additional types of functionality, such as a text editor, a word processor, an email client, a messaging client, a calendar, an address book, a telephone dialer, an image gallery or any other suitable type of functionality.

The first application 227 also includes one or more application modes associating context vectors with one or more display attributes. For example, the first application 227 includes a first set of application modes each associating one or more display attributes with context vectors. Similarly, the second application 228 includes one or more application modes associating context vectors with one or more display attributes. For example, the second application 228 includes a second set of application modes each associating one or more display attributes with context vectors. Display attributes from the application modes are used along with display attributes from a container mode to modify the appearance of data on the display device 240 responsive to a context vector. Use of the application modes and container mode is further described below in conjunction with FIGS. 4-6.

The input device 230 is any device configured to receive input and to communicate the received input to the processor 210, to the storage device 220 or to another component of the portable computing device 110 via the bus 205. For example, the input device 230 comprises a cursor controller, a touch-sensitive display or a keyboard. In one embodiment, the input device 230 includes an alphanumeric input device, such as a keyboard, a key pad, representations of such created on a touch-sensitive display or another device adapted to communicate information and/or commands to the processor 210 or to the storage device 220. In another embodiment, the input device 230 comprises a device for communicating positional data as well as data or commands to the processor 210 or to the storage device 220 such as a joystick, a mouse, a trackball, a stylus, a touch-sensitive display, directional keys or another suitable input device known in the art.

The display device 240 is a device that displays electronic images and/or data. For example, the display device 240 comprises an organic light emitting diode display (OLED), a liquid crystal display (LCD) or any other suitable device, such as a monitor. In one embodiment, the display device 240 includes a touch-sensitive transparent panel for receiving data or allowing other interaction with the images and/or data displayed by the display device 240.

The output device 250 comprises one or more devices that convey data or information to a user of the portable computing device 110. For example, the output device 250 includes one or more speakers or headphones for presenting audio data to a user. As another example, the output device 250 includes one or more light emitting diodes (LEDs) or other light sources to provide visual data to a user. As another example, the output device 250 includes one or more devices for providing vibrational, or haptic, feedback to a user. The above are merely examples and the output device 250 may include one or more devices for providing auditory output, tactile output, visual output, any combination of the preceding or any other suitable form of output.

The communication unit 260 transmits data from portable computing device 110 to the network 140 or to other portable computing devices 110 and/or receives data from a server 120 or a content provider 130 via the network 140. In one embodiment, the communication unit 260 comprises a wireless transceiver that transmits and/or receives data using one or more wireless communication protocols. For example, the communication unit 260 includes one or more wireless transceivers transmitting and/or receiving data using one or more wireless communication protocols, such as IEEE 802.11 a/b/g/n (WiFi), Global System for Mobile (GSM), Code Division Multiple Access (CDMA), Universal Mobile Telecommunications System (UMTS), General Packet Radio Service (GPRS), second-generation (2G), or greater, mobile network, third-generation (3G), or greater, mobile network, fourth-generation (4G), or greater, mobile network, High Speed Download Packet Access (HSDPA), High Speed Uplink Packet Access (HSUPA), Long-Term Evolution (LTE), Worldwide Interoperability for Microwave Access (WiMax), near field communication (NFC), BLUETOOTH® or another wireless communication protocol. In another embodiment, the communication unit 260 is a network adapter or other type of wired communication port for communicating with a network 140 or with another portable computing device 110 using a wired communication protocol, such as Universal Serial Bus (USB), Ethernet or another suitable wired communication protocol. In yet another embodiment, the communication unit 260 comprises a combination of one or more transceivers and a wired network adapter, or similar wired device.

The one or more physical sensors 270 capture data describing an environment external to the portable computing device 110 and/or physical properties of the portable computing device 110. The one or more physical sensors 270 are coupled to the processor 210, storage device 220, input device 230, display device 240, output device 250 and/or communication unit 260 via the bus 205. For example, a physical sensor 270 comprises a light sensor generating data describing an amount of ambient light. As another example, a physical sensor 270 comprises a microphone capturing audio data. Another example of a physical sensor 270 is a proximity sensor generating data describing the distance from the portable computing device 110 to an object, such a user. Additional examples of physical sensors 270 include one or more devices capturing a temperature of the portable computing device 110 or of an environment including the portable computing device 110, a humidity of the environment including the portable computing device 110, a pressure of the environment including the portable computing device 110, or a pressure applied to the one or more devices. Further examples of physical sensors 270 capture data describing one or more attributes of a user of the portable computing device 110. For example one or more physical sensors 270 capture data describing a heart rate, a blood pressure, a glucose level, a blood alcohol level, a blood oxygen content or other suitable physiological data of a user of the portable computing device 110. However, the above are merely examples of physical sensors 270, and in various embodiments different and/or additional types of physical sensors 270 may be used.

In one embodiment, a physical sensor 270 comprises an orientation sensor 272 determining an orientation associated with the portable computing device 110. For example, the orientation sensor 272 comprises a tilt sensor measuring tilting in two or more axes of a reference plane. In one embodiment, the orientation sensor 272 comprises an accelerometer determining an orientation of the portable computing device 110. The orientation sensor 272 may generate a first control signal responsive to determining the portable computing device 110 has a first orientation and generates a second control signal responsive to determining the portable computing device 110 has a second orientation. For example, the orientation sensor 272 generates the first control signal responsive to determining the portable computing device 110 has a first orientation relative to a reference plane and generates the second control signal responsive to determining the portable computing device 110 has a second orientation relative to the reference plane. For example, the orientation sensor 272 generates the first control signal responsive to being perpendicular to a reference plane and generates the second control signal responsive to being parallel to the reference plane. In one embodiment, the first orientation and the second orientation are orthogonal to each other, such as a landscape orientation and a portrait orientation.

### Methods

FIG. 3 is an event diagram of one embodiment of a method 300 for modifying a display configuration of a portable computing device 110. In some embodiments, the method 300 includes different and/or additional steps than those shown by FIG. 3. Moreover, in some embodiments, certain steps in the method 300 may be performed in a different order than illustrated by FIG. 3.

One or more virtual sensors 222 generate 305 data describing an operating condition associated with the portable computing device 110 and transmit 320 the generated data to the context engine 224 via the bus 205. In one embodiment, a virtual sensor 222 determines whether a second device is coupled to the portable computing device 110. Examples of data generated 305 by one or more virtual sensors 222 include data indicating whether a second portable computing device 110 is communicating with the portable computing device 110 via the communication unit 260 and/or whether the portable computing device 110 is coupled to an external display device via the communication unit 260. Additional examples of data generated 305 by one or more virtual sensors 222 include the amount or frequency of interaction with the portable computing device 110, a number of applications executed by the portable computing device 110 and/or a semantic location and/or position associated with the portable computing device 110.

One or more physical sensors 270 also receive 310 data describing an environment external to the portable computing device 110 and/or physical properties of the portable computing device 110 and transmit 315 the data to the context engine 224 via the bus 205. Examples of data received 310 by the physical sensors 270 include a geographic location of the portable computing device 110, an amount of ambient light proximate to the portable computing device 110 and/or the distance from the portable computing device 110 to an object, such a user. As another example, one or more physical sensors 270 may receive 310 data describing an orientation associated with the portable computing device 110.

The context engine 224 determines 325 a context vector using the data from the one or more virtual sensors 222 and from the one or more physical sensors 270. For example, the context engine 224 compares data from one or more physical sensors 270 and from one or more virtual sensors 222 to stored context vectors associated with different values from one or more physical sensors 270 and/or virtual sensor 222 and selects the stored context vector having the highest similarity to the received data. For example, the context engine 224 calculates the Hamming distance between data associated with stored context vectors and data received from one or more physical sensors 270 and/or virtual sensors 222 and determines 325 a stored context vector using the Hamming distance. This allows the context engine 224 to approximate a user's interaction with the portable computing device 110 using data from one or more physical sensors 270 and from one or more virtual sensors 222.

After determining the context vector, the context engine 224 requests 330 an application mode associated with the context vector from the first application 227 via the bus 205 and requests 340 an application mode associated with the context vector from the second application 228 via the bus 205. The first application 227 determines an application mode associated with the context vector and transmits 335 the application mode associated with the context vector to the context engine 224. Similarly, the second application 228 transmits 345 the application mode associated with the context vector to the context engine 224. In one embodiment, the first application 227 and/or the second application 228 compares the context vector to stored application mode-specific context vectors to identify an application mode corresponding to the context vector.

Similarly, the context engine 224 requests 350 a container mode associated with the context vector from the display container 226 via the bus 205. In one embodiment, the display container 226 identifies a container mode associated with the context vector from a stored set of container modes. The display container 226 transmits 355 the container mode associated with the context vector to the context engine 224 via the bus 205.

The context engine 224 then determines 360 a display configuration based on the application mode received from the first application 227, the application mode received from the second application 228 and the container mode. The display configuration is used by the processor 210 to modify the presentation of data using the display device 240. In one embodiment, the display configuration modifies a window size associated with the first application 227 and/or the second application 228 to modify the amount or type of information displayed by one or more applications. Alternatively, the display configuration modifies the position of the first application 227 and/or the second application 228 to allow an application to be more easily viewed. The display configuration may also modify a state of the first application 227 and/or a state of the second application 228 to modify the visibility of data associated with an application. In one embodiment, the display configuration may also include an instruction for displaying an additional application using the display device 240.

In determining 360 the display configuration, the context engine 224 identifies display attributes from one or more of the application mode received from the first application 227, the application mode received from the second application 228 and the container mode for displaying data. In various embodiments, the display configuration uses display attributes from one of the application mode received from the first application 227, the application mode received from the second application 228 and the container mode to provide a uniform presentation of data. Alternatively, the display configuration uses subsets of display attributes selected from on the application mode received from the first application 227, the application mode received from the second application 228 and the container mode to differently display data associated with different applications. Examples of determining 360 the display configuration are further described below in conjunction with FIGS. 4-6. The determined display configuration is transmitted 365 from the context engine 224 to the display device 240, which displays the first application 227 and the second application 228 using the display configuration.

FIG. 4 is a flow chart of a method for determining 360 a display configuration of a portable computing device 110 using an application mode associated with a context vector by a first application 227 in accordance with some embodiments. The context engine 224 determines 405 whether the first application 227 includes an application mode associated with the context vector. For example, the context engine 224 determines 405 whether an application mode was received from the first application 227 or whether a message indicating the first application 227 does not include an application mode associated with the context vector was received. Responsive to determining 405 the first application 227 includes an application mode associated with the context vector, the context engine 224 configures 410 the display configuration to display data associated with the first application 227 using the application mode associated with the context vector by the first application 227.

The context engine 224 determines 415 whether the second application 228 includes an application mode associated with the context vector. For example, the context engine 224 determines 415 whether an application mode was received from the second application 228 or whether a message indicating the second application 228 does not include an application mode associated with the context vector was received. Responsive to determining 415 the second application 228 includes an application mode associated with the context vector, the context engine 224 configures 420 the display configuration to display data associated with the second application 228 using the application mode associated with the context vector by the second application 228. Responsive to determining 415 the second application 228 does not include an application mode associated with the context vector, the context engine 224 configures 425 the display configuration to display data associated with the second application 228 using the container mode associated with the context vector by the display container 226 and to display data associated with the first application 227 using the application mode associated with the context vector by the first application 227.

However, responsive to determining 405 the first application 227 does not include an application mode associated with the context vector, the context engine 224 determines 430 whether the second application 228 includes an application mode associated with the context vector. Responsive to determining 430 the second application 228 includes an application mode associated with the context vector, the context engine 224 configures 435 the display configuration to display data associated with the second application 228 using the application mode associated with the context vector by the second application 228 and to display data associated with the first application 227 using the container mode associated with the context vector by the display container 226. Responsive to determining 415 the second application 228 does not include an application mode associated with the context vector, the context engine 224 configures 440 the display configuration to display data associated with the first application 227 and data associated with the second application 228 using the container mode associated with the context vector by the display container 226.

Thus, the embodiment shown by FIG. 4 displays application data associated with an application using display attributes from application modes associated with the context vector by the applications, allowing different applications to specify how associated data is displayed. When an application does not associate an application mode with a context vector, in the embodiment illustrated by FIG. 4, display attributes from the display container 226 are used to display data associated with different applications.

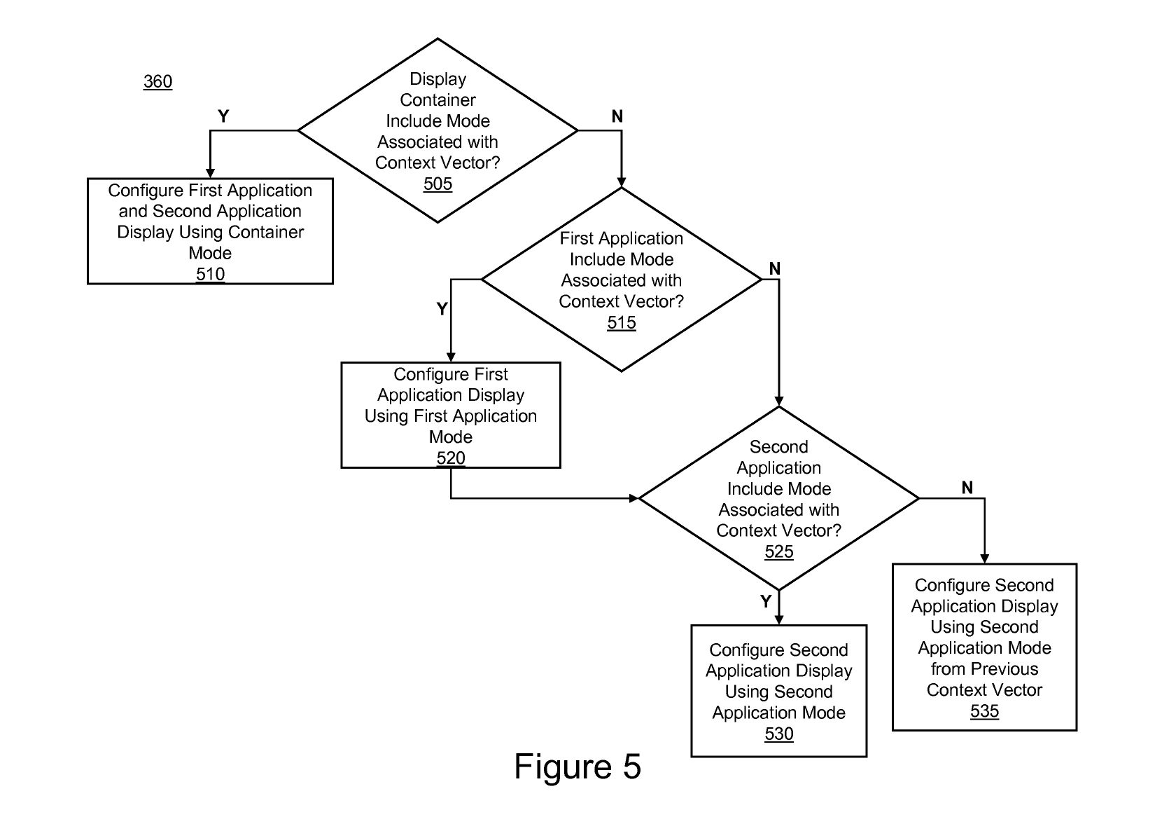

FIG. 5 is a flow chart of an alternative method for determining 360 a display configuration of a portable computing device 110 using an application mode associated with a display container 226 in accordance with some embodiments. The context engine 224 determines 505 whether the display container 226 includes a container mode associated with the context vector. Responsive to determining 505 the display container 226 includes a container mode associated with the context vector, the context engine 224 configures 510 the display configuration to display data associated with the first application 227 and data associated with the second application 228 using the container mode associated with the context vector by the display container 226.

Responsive to determining 505 the display container 226 does not include a container mode associated with the context vector, the context engine 224 determines 515 whether the first application 227 includes an application mode associated with the context vector. If the first application 227 includes an application mode associated with the context vector, the context engine 224 configures 520 the display configuration to display data associated with the first application 227 using the application mode associated with the context vector by the first application 227. If the first application 227 does not include an application mode associated with the context vector, the context engine 224 determines 525 whether the second application 228 includes an application mode associated with the context vector. Responsive to determining 525 the first application 227 does not include an application mode associated with the context vector and determining 505 the display container does not include a container mode associated with the context vector, the context engine 224 configures the display configuration to display data associated with the first application 227 using an application mode associated with a previously-determined context vector by the first application 227 or using a container mode associated with the previously-determined context vector by the display container 226. Thus, a container mode or an application mode associated with a previously-determined context vector may be used for displaying data associated with the second application 228 if no display attributes are identified by either the display container 226 or by the first application 227 as associated with the context vector.

Responsive to determining 525 the second application 228 includes an application mode associated with the context vector, the context engine 224 configures 530 the display configuration to display data associated with the second application 228 using the application mode associated with the context vector by the second application 228. However, responsive to determining 525 the second application 228 does not include an application mode associated with the context vector, the context engine 224 configures 535 the display configuration to display data associated with the second application 228 using a container mode associated with a previously-determined context vector by the display container 226. Thus, a container mode associated with a previously-determined context vector may be used for displaying data associated with the second application 228 if no display attributes are identified by either the display container 226 or an application as associated with the context vector. In an alternative embodiment, a default mode including a default set of display attributes may be used to display data associated with an application when neither the display container 226 or the application associate a display mode with a context vector.

Thus, the embodiment shown by FIG. 5 displays application data associated with an application using display attributes from a container mode associated with the context vector by the display container 226, so data associated with different applications is displayed using display attributes from the display container 226, providing a uniform appearance for data associated with different applications. When the display container 226 does not associate a container mode with a context vector, in the embodiment illustrated by FIG. 5, display attributes from application modes associated with the context vector by the applications are used to display data associated with the different applications.

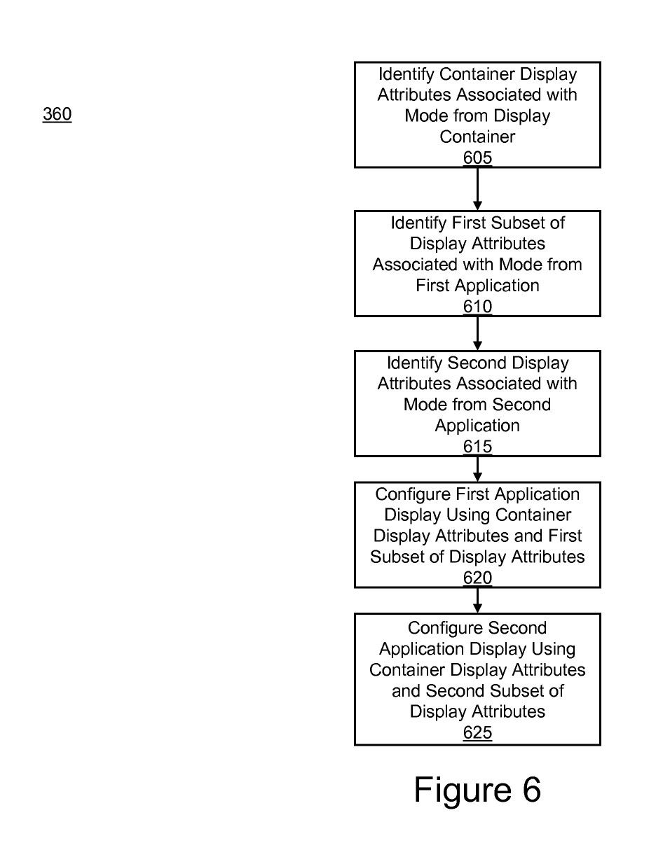

FIG. 6 is a flow chart of another method for determining 360 display of a first application 227 and a second application 228 using display attributes associated with the first application 227, the second application 228 and a display container 226 in accordance with some embodiments. The context engine 224 identifies 605 display attributes from a container mode associated with a context vector by the display container 226. In one embodiment, the display attributes in the container mode describe the appearance of data displayed independent of an application. For example, the container mode display attributes describe display of data that is not associated with an application or that is displayed by an application not including an application mode associated with the container mode. This allows the display container 226 to provide default display settings.

The context engine 224 also identifies 610 a first subset of display attributes from the application mode associated with the context vector by the first application 227 and identifies 615 a second subset of display attributes from the application mode associated with the context vector by the second application 228. The display attributes associated with the context vector by an application describe how data associated with the application is displayed. For example, a display attribute associated with the context vector by the first application 227 specifies a window size and position associated with the first application 227, indicating where data associated with the first application 227 is displayed by the display device 240. As another example, a display attribute associated with the second application 228 specifies a state indicating whether the second application 228 is receiving input from an input device 230.

The context engine 224 configures 620 the display configuration so data associated with the first application 227 is displayed using the container mode display attributes and the first subset of the display attributes. In one embodiment, the display configuration is configured 620 to display a subset of data associated with the first application 227 using the first subset of the display attributes and a second subset of data associated with the first application 227 using the container mode display attributes. For example, data identifying the title or menus of the first application 227 is displayed using the container mode display attributes while data generated by the first application 227 is displayed using the first subset of the display attributes. As another example, data associated with the first application 227 is displayed using the first subset of the display attributes while displayed data not associated with the first application 227 or the second application 228 is displayed using the container mode display attributes.

Similarly, the context engine 224 configures 625 the display configuration data associated with the second application 228 is displayed using the container mode display attributes and the second subset of the display attributes. Thus, display attributes associated with a context vector an application as well as display attributes associated with the context vector by the display container 226 is used to modify the appearance of data associated with the application. This allows customization of the appearance of application data based on context vector-specific display attributes, allowing changes in the context vector to modify display of data associated with an application.

Thus, the embodiment shown by FIG. 6 displays application data associated different applications using a combination of display attributes from a container mode and application modes associated with a context vector. This allows different data associated with an application to be displayed using display attributes from the application and the display container.

In various embodiments, steps illustrated by the methods shown by FIGS. 3-6 are implemented by instructions for performing the described actions embodied, or stored, within a non-transitory computer readable storage medium that, when executed by a processor 210, provide the functionality further described below. Examples of a non-transitory computer readable storage medium, such as the storage device 220, include flash memory, random access memory (RAM) or any other suitable medium known to one skilled in the art.

The methods shown in FIGS. 3-6 may be implemented in embodiments of hardware, software or combinations of hardware and software. In one embodiment, instructions for performing the actions described below are stored in the storage device 220 of the portable computing device 110, such as in the context engine 224, and execution of the instructions by the processor 210 performs the actions described above in conjunction with FIGS. 3-6.

### Example Operation

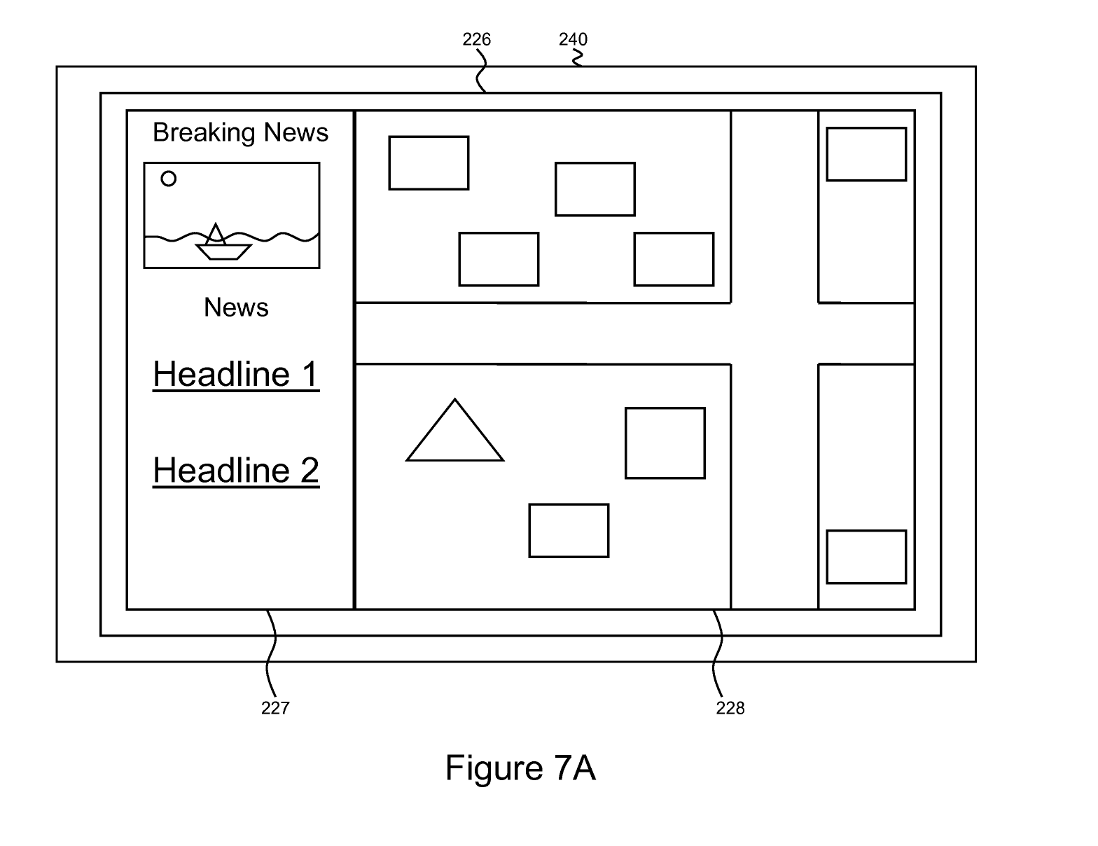

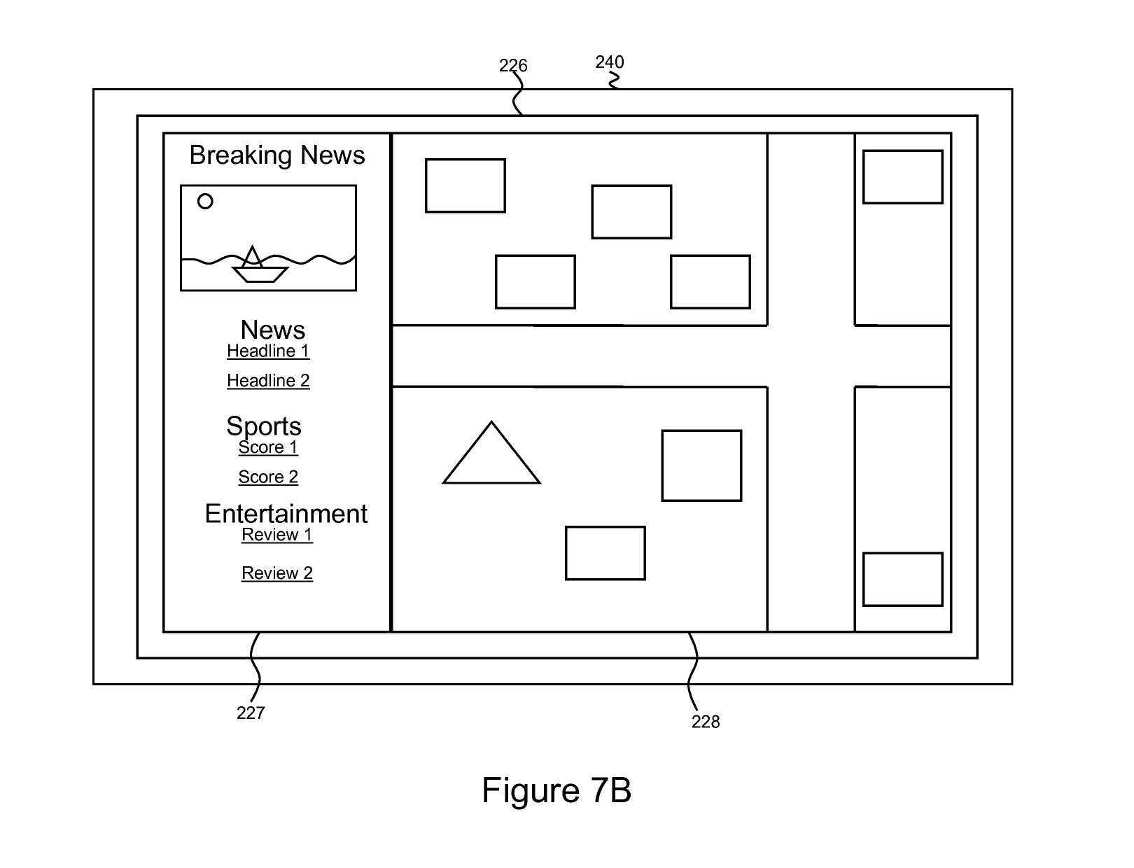

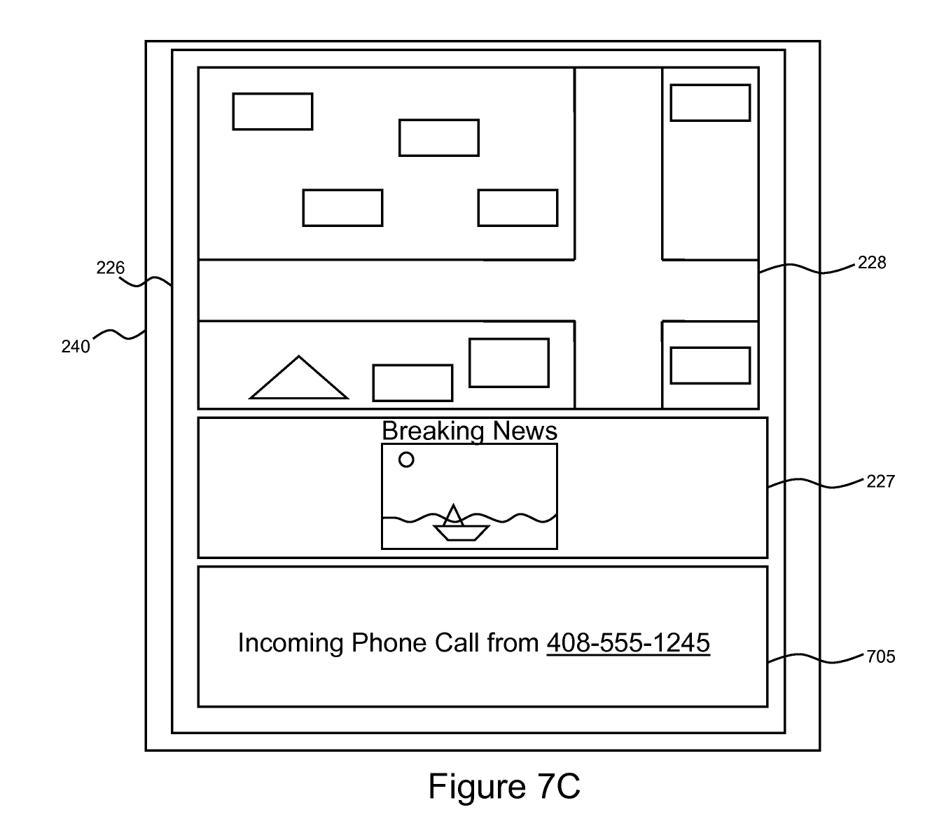

FIGS. 7A-7C are examples of modifying display of application data by a display device 240 of a portable computing device 110 based on display attributes associated with a context vector in accordance with some embodiments. In FIG. 7A, the context engine 224 determines a first context vector indicating a user of the portable computing device 110 is interacting with a second application 228. Based on application modes associated with the first context vector by the first application 227 and by the second application 228, the window size and position of the second application 228 within the display container 226 is configured to simplify viewing and interaction with the second application 228. The application mode associated with the context vector by the first application 227 specifies a state and window size of the first application 227 so that a limited amount of content is displayed in the display container 226. In the example of FIG. 7A, the first application 227 is a news application or web browser and the application mode associated with the first application 227 displays headlines or another subset of the data capable of being viewed using the first application 227.

In FIG. 7B, the context engine 224 determines a second context vector based on data from a virtual sensor 222 and/or a physical sensor 270 indicating increased user interaction with the first application 227. For example, a virtual sensor 222 determines that a threshold amount or frequency of interaction with the first application 227 occurred within a time interval. The context engine 224 determines an application mode associated with the second context vector by the first application 227 and by the second application 228. In the example of FIG. 7B, the application mode associated with the second context vector by the second application 228 does not modify the window size, position, state or other attribute of the second application 228.

In the example of FIG. 7B, the application mode associated with the second context vector by the first application 227 modifies the state of the first application 227 to increase the amount of data displayed by the first application 227. For example, the news application or web browser shown in FIG. 7A is modified to display different categories as well as information associated with the categories. Thus, the change in context vector reflects the increased interaction with the first application 227, increasing the amount of data displayed by the first application 227.

FIG. 7C illustrates the context engine 224 determining a third context vector responsive to data from a virtual sensor 222 and/or a physical sensor 270 indicating a change in orientation of the portable computing device 110 and receipt of an incoming message. For example, the context engine 224 receives data from an orientation sensor 272 describing a new orientation of the portable computing device 110 and data from a virtual sensor 222 indicating a communication unit 260 is receiving a phone call and determines a third context vector accordingly. The context engine 224 then determines an application mode associated with the second context vector by the first application 227, by the second application 228 and by the display container 226.

In the example of FIG. 7C, the application mode associated with the third context vector by the first application 227 modifies the window size and position of the first application 227 and modifies the state of the first application 227 to reduce the amount of data displayed by the first application 227. Also in the example of FIG. 7C, the application mode associated with the third context vector by the second application 228 modifies the window size and position of displayed data associated with the second application 228. Also in the example of FIG. 7C, the application mode associated with the third context vector by the second application 228 modifies the state of the second application 228 so that the data displayed by the second application 228 is reduced in size when displayed.

Additionally, in the example shown by FIG. 7C, a third application 705 is displayed in the display container 226 in response to the detection of an incoming telephone call by a virtual sensor 222. In one embodiment, the third application 705 is displayed based on display settings associated with the third context vector by the display container 226. For example, display attributes associated with the third context vector by the display container 226 indicates the window size and location of displayed data associated with the third application 705.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “ha . . . a,” “includes . . . a,” or “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. In some embodiments, a combination of the two approaches may be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions, programs and/or integrated circuits with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method comprising:
determining a context vector from data describing a position associated with a device and data describing an operating condition associated with the device;
identifying a first application mode associated with a first application, the first application mode associated with the context vector;
identifying a second application mode associated with a second application, the second application mode associated with the context vector;
identifying a container mode associated with the context vector and associated with a display container in which the first application and the second application are displayed;
determining a display configuration based on the first application mode, the second application mode and the container mode, the display configuration identifying display attributes of the first application, display attributes of the second application and display attributes of the container mode; and
displaying, on a display device, data associated with the first application and data associated with the second application using the display configuration.

2. The method of claim 1, wherein determining the context vector from data describing the position associated with the device and data describing the operating condition associated with the device comprises:
receiving data describing an orientation associated with the device from one or more physical sensors; and
receiving data describing the operating condition associated with the device from one or more virtual sensors.

3. The method of claim 2, wherein receiving data describing the operating condition associated with the device from one or more virtual sensors comprises:
receiving data, via the one or more virtual sensors, describing one or more of a semantic location of the device, an amount of user interaction with the device or a number and type of applications being executed by the device.

4. The method of claim 2, wherein receiving data describing the operating condition associated with the device from one or more virtual sensors comprises:
receiving data describing operation of a second device via the one or more virtual sensors.

5. The method of claim 2, wherein receiving data describing the position associated with the device from one or more physical sensors comprises:
receiving data describing one or more of an orientation of the device, an amount of ambient light near the device, an amount of pressure applied to the device, a temperature associated with an environment including the device, a pressure associated with the environment including the device and an amount of ambient sound near the device.

6. The method of claim 1, wherein determining the display configuration based on the first application mode, the second application mode and the container mode comprises:
determining whether the first application mode includes a display attribute;
responsive to the first application mode not including the display attribute, identifying the display attribute from the container mode; and
including the display attribute from the container mode in the display configuration.

7. The method of claim 1, wherein determining the display configuration based on the first application mode, the second application mode and the container mode comprises:
determining whether the container mode includes a display attribute;
responsive to the container mode including the display attribute, including the display attribute from the container mode in the display configuration; and
responsive to the container mode not including the display attribute, identifying the display attribute from the first application mode; and
including the display attribute from the first application mode in the display configuration.

8. The method of claim 1, wherein determining the display configuration based on the first application mode, the second application mode and the container mode comprises:
including a first subset of display attributes from the first application mode in the display configuration, the first subset of display attributes describing display of data associated with the first application;
including a second subset of display attributes from the second application mode in the display configuration, the second subset of display attributes describing display of data associated with the second application; and
including a third subset of display attributes from the container mode in the display configuration, the second subset of display attributes describing display of data included in the display container.

9. The method of claim 1, wherein the display configuration includes data modifying at least one of: a state associated with the first application, a state associated with the second application, a window size associated with the first application, a window size associated with the second application, a position associated with the first application, a position associated with the second application or an instruction for displaying an additional application by the display device.

10. The method of claim 1, wherein determining the context vector from data describing the position associated with the device and data describing the operating condition associated with the device comprises:
identifying a trigger condition included in the data describing the position associated with the device or the data describing the operating condition associated with the device; and
identifying a context vector associated with the trigger condition.

11. The method of claim 1, wherein displaying, on the display device, data associated with the first application and data associated with the second application using the display configuration comprises:
displaying a subset of the data associated with the first application using a first subset of display attributes from the first application mode;
displaying a subset of the data associated with the second application using a second subset of display attributes from the second application mode; and
displaying a second subset of the data associated with the first application and a second subset of the data associated with the second application using a third subset of display attributes from the container mode.

12. A non-transitory computer readable storage medium coupled to a processor, the non-transitory computer readable storage medium including instructions that, when executed by the processor, cause the processor to:
determine a context vector from data describing an orientation associated with a device including the processor and data describing an operating condition associated with the device;
identify a first application mode associated with a first application, the first application mode associated with the context vector;
identify a second application mode associated with a second application, the second application mode associated with the context vector;
identify a container mode associated with the context vector and associated with a display container in which the first application and the second application are displayed;
determine a display configuration based on the first application mode, the second application mode and the container mode, the display configuration identifying display attributes of the first application, display attributes of the second application and display attributes of the container mode; and
display, on a display device, data associated with the first application and data associated with the second application using the display configuration.

13. The non-transitory computer readable storage medium of claim 12, wherein determine the context vector from data describing the position associated with the device and data describing the operating condition associated with the device comprises:
receiving data describing an orientation associated with the device from one or more physical sensors; and
receiving data describing the operating condition associated with the device from one or more virtual sensors.

14. The non-transitory computer readable storage medium of claim 13, wherein receiving data describing the operating condition associated with the device from one or more virtual sensors comprises:
receiving data, via the one or more virtual sensors, describing one or more of a semantic location of the device, an amount of user interaction with the device or a number and type of applications being executed by the device.

15. The non-transitory computer readable storage medium of claim 13, wherein receiving data describing the operating condition associated with the device from one or more virtual sensors comprises:
receiving data describing operation of a second device via the one or more virtual sensors.

16. The non-transitory computer readable storage medium of claim 13, wherein receiving data describing the position associated with the device from one or more physical sensors comprises:
receiving data describing one or more of an orientation of the device, an amount of ambient light near the device, an amount of pressure applied to the device, a temperature associated with an environment including the device, a pressure associated with the environment including the device and an amount of ambient sound near the device.

17. The non-transitory computer readable storage medium of claim 12, wherein determine the display configuration based on the first application mode, the second application mode and the container mode comprises:
determining whether the first application mode includes a display attribute;
responsive to the first application mode not including the display attribute, identifying the display attribute from the container mode; and
including the display attribute from the container mode in the display configuration.

18. The non-transitory computer readable storage medium of claim 12, wherein determine the display configuration based on the first application mode, the second application mode and the container mode comprises:
determining whether the container mode includes a display attribute;
responsive to the container mode including the display attribute, including the display attribute from the container mode in the display configuration; and
responsive to the container mode not including the display attribute, identifying the display attribute from the first application mode; and
including the display attribute from the first application mode in the display configuration.

19. The non-transitory computer readable storage medium of claim 12, wherein determine the display configuration based on the first application mode, the second application mode and the container mode comprises:
including a first subset of display attributes from the first application mode in the display configuration, the first subset of display attributes describing display of data associated with the first application;
including a second subset of display attributes from the second application mode in the display configuration, the second subset of display attributes describing display of data associated with the second application; and
including a third subset of display attributes from the container mode in the display configuration, the second subset of display attributes describing display of data included in the display container.

20. The non-transitory computer readable storage medium of claim 12, wherein the display configuration includes data modifying at least one of: a state associated with the first application, a state associated with the second application, a window size associated with the first application, a window size associated with the second application, a position associated with the first application, a position associated with the second application or an instruction for displaying an additional application by the display device.
